(19) United States
(12) Patent Application Publication
(10) Pub. No.: US 2026/0224925 A1
(43) Pub. Date: Aug. 6, 2026

(54) MULTI-LAYER FIRE CURTAIN

(71) Applicant: McKeon Rolling Steel Door Co., Inc., Bellport, NY (US)

(72) Inventors: Andrew C. LAMBRIDIS, Dix Hills, NY (US); Ashraf GOMAA, Stony Brook, NY (US)

(73) Assignee: McKeon Rolling Steel Door Co., Inc., Bellport, NY (US)

(21) Appl. No.: 19/039,597

(22) Filed: Jan. 28, 2025

(51) Int. Cl. A62C 2/10

(52) U.S. Cl. CPC A62C 2/10

(57) ABSTRACT

A multi-layer rolling fire curtain assembly having guide channels arranged along a right-side edge and a left-side edge of an opening, a flexible multi-layer fire curtain configured to be wrapped about a roller and deployable between a retracted position and an extended position, the curtain having a first end connected, directly or indirectly, to the curtain roller, and a second end connected, directly or indirectly, to a bottom bar, the having an inner layer in contact with the roller and having a first width W₁, and an outer layer arranged opposite the inner layer, wherein the outer layer has a second width W₂ less than W₁ and is longer than the inner curtain layer to form a baggy area therebetween. The multi-layer fire curtain is configured and arranged so as to be received in and guided along a respective one of the first and second guide channels.

### TECHNICAL FIELD

The present application relates to the field of fire curtains, and rolling door (i.e., rolling curtain) assemblies for deployment of such curtains, which are arranged in an opening of a building to provide a rolling fire resistant door assembly.

### BACKGROUND OF THE DISCLOSURE

Fire curtains are used in buildings to contain and control fires, and to protect people and property during a fire. In particular, fire curtains can help control the spread of smoke, which can be deadly. Fire curtains are often used in large, open-plan buildings where conventional type swinging fire doors are not practical. They are made of fire-resistant materials and are designed to descend from the ceiling to cover the area.

Due to their flexibility, fire curtains are typically deployed and retracted from a rolling assembly which includes a roller positioned above an opening in a wall, such as a doorway. A flexible panel, or curtain, is wrapped around the roller so that it can be extended into, and retracted away from, the opening. In the deployed and extended position, the curtain’s leading edge sits parallel with and flush on the ground.

The fire curtain has lateral edges which are received in and guided along guide channels disposed along a right-side edge and left-side edge of the doorway. The channels act as a guide during extension and retraction of the flexible door panel in the doorway. In some instances, fire curtains may also be deployed horizontally.

Fabric, i.e., textile, fire curtains are known for use as the flexible door panel. However, some fabrics, while fire retardant, will, after being exposed to fire in a test scenario – a requirement for certification approval -- fail endurance tests required by various testing agencies and organizations. There is, therefore, a need for a configuration of a fabric fire curtain and a rolling door system incorporating same, that will pass such testing requirements.

### SUMMARY OF THE DISCLOSURE

In view of the foregoing, it is an object of the invention to provide an improved rolling fire and smoke blocking curtain, and in particular a multi-panel, i.e., multi-layer, curtain for fire prevention. The terms “curtain” and “door” and “shutter” are used interchangeably herein. Likewise, the terms “panel” and “layer” are used interchangeably herein. The same is true of the terms “fire resistant” and “fire retardant” and for “opening” and “doorway”.

In accordance with a first aspect of the invention, a multi-layer rolling fire curtain assembly is positionable about an opening, and includes a rotatable curtain roller having a longitudinal axis and positionable about the opening, first and second guide channels arranged along a right-side edge and left-side edge of the opening, respectively, and a flexible multi-layer fire curtain comprising fire resistant material and being configured to be wrapped about the curtain roller and to be deployable from the curtain roller between a retracted position and an extended position, the multi-layer fire curtain having a first end connected, directly or indirectly, to the curtain roller, and a second end connected, directly or indirectly, to a bottom bar. The multi-layer fire curtain has an inner curtain layer arranged in contact with the curtain roller and having a first width W₁ between first and second lateral edges, and an outer curtain layer arranged opposite the inner curtain layer, wherein the outer curtain layer is longer than the inner curtain layer and a second width W₂ less than W₁ and is longer than the inner curtain layer to form a baggy area therebetween. The multi-layer fire curtain is configured and arranged so as to be received in and guided along a respective one of the first and second guide channels.

In another aspect, the multi-layer fire curtain is flexible, establishes a fire barrier across the structure opening in the extended position, and the fire resistant inner and outer layers are each made of a fire resistant textile material.

In another aspect, the second width W₂ of the outer curtain layer is outside the first and second guide channels to allow for ventilation from between the inner and outer curtain layers.

In another aspect, the multi-layer rolling fire curtain assembly further includes a motor configured to drive the rotatable curtain roller to wind the multi-layer fire curtain onto the rotatable curtain roller.

In another aspect, the multi-layer rolling fire curtain assembly further includes one or more intermediate layers, of textile or non-textile material, arranged so as to be sandwiched between the inner and outer fire resistant textile layers. The intermediate layers may be made of a fire retardant composite material, a fire retardant metallic material or any suitable material to increase the fire protection capabilities of the assembly.

In another aspect, the one or more intermediate layers have staggered lengths that are longer than the inner curtain layer and shorter than the outer curtain layer.

In another aspect, the one or more intermediate layers may have the first width W₁ or the second width W₂.

In another aspect, the width of one of the inner and outer curtain layers is less than the width of the other of the inner and outer curtain layers so as to provide venting at both horizontally outer ends of the one of the inner and outer curtain layers, to allow for ventilation from between the inner and outer curtain layers.

In another aspect, the multi-layer rolling fire curtain assembly further includes a bottom bar connected, directly or indirectly, to a leading edge of the second end of the multi-layer fire curtain.

In another aspect, in a case in which the multi-layer fire curtain is in a fully extended closed position, the bottom bar is parallel with and in contact with the ground.

In another aspect, the bottom bar is connected, directly or indirectly, to the leading edge of the second end of the multi-layer fire curtain by clamping or any other means of secure attachment.

In another aspect, the flexible multi-layer fire curtain is connected to the roller directly or indirectly.

In another aspect, the lateral edges of the outer curtain layer do not extend into the channels, so as to form a vent at each lateral edge of the outer curtain layer.

### BRIEF DESCRIPTION OF THE DRAWINGS

The drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein. In the drawings:

FIG. 1 is an front view of a rolling fire curtain assembly according to an aspect of the present invention;

FIGS. 2A and 2B are side sectional views of the system shown in FIG. 1;

FIG. 3 is a plan view of the system shown in FIG. 1;

FIG. 4 is a side sectional view of a two-layer fire curtain according to an aspect of the present invention showing the lower uncoiled part of the fire curtain; and

FIG. 5 is a plan view of fire curtain assembly of FIG. 1.

FIG. 6A and 6B are front views of a multi-layer fire curtain, in embodiments.

### DETAILED DESCRIPTION OF THE DISCLOSED EMBODIMENTS

Elements performing the same or similar functions will be indicated using the same or similar reference characters.

The present invention is directed to fire curtain assembly having a fire curtain including multiple separate layers deployed from a roller. The use of multiple layers in the curtain is advantageous, at least because it provides one or more extra layers of fire retardant, and smoke blocking, textile.

Moreover, the disclosed multi-layer arrangement of fire retardant and/or resistant textiles is particularly advantageous when multiple, for example two or more, textile layers are used in conjunction with one or more additional non-textile fire retardant layers. Throughout the disclosure and claims, the term “panel” is used interchangeably with the term “layer.”

In one aspect of the present invention a two-layer textile curtain is provided, with a first, inner textile layer arranged closer to the roller, and the second outer layer arranged opposite the inner one.

In a further embodiment, these two textile layers are employed to sandwich an intermediate fire or smoke retardant layer or layers, providing protection to the additional layer. For example, additional layer or layers, which may be of textile or non-textile material, are more likely to survive a fire if it is sandwiched between textile layers. This provides additional advantages and protection to the building and its occupants, e.g., temperature rise rating and increased fire resistant rating.

In a still further embodiment, venting is provided at both horizontally outer ends of one of the curtain layers, to reduce the risk of combustion within the baggy portion formed between the layers.

When two or more fabric layers are rolled up on a shutter roller, such as in rolling door/curtain/shutter assemblies, the outermost layer must travel a greater distance than the innermost layer. Moreover, if two separate layers contact one another over the entire extent of the deployment, the inner side fabric will pull on the outer fabric.

Also, in view of the different distance of travel, the outer layer or layers making up the multi-layer fire curtain will not remain taught during retraction of the curtain because the rolling diameters for these two or more layers is different. This is because the inner layer only wraps around the roller, at least to begin with, while the outer layer or layers wrap around the diameter of the roller and the additional thickness of the inner layer or layers. The fabric or flexible material may also develop broad wrinkles over extended use which may lead to an uneven deployment to and from the roller which may lead to the edges of the fire curtain jamming in the guides, which can lead to damage of the curtain.

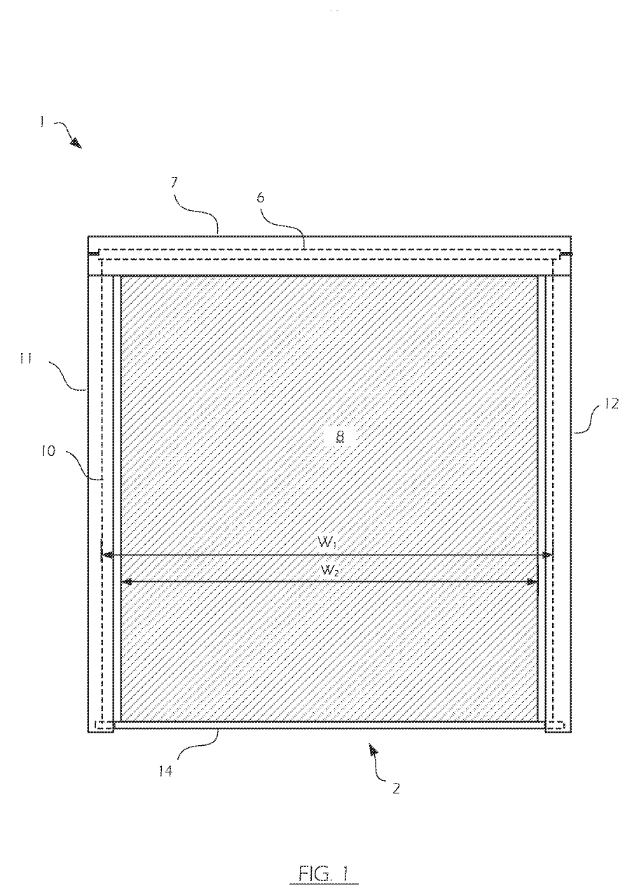

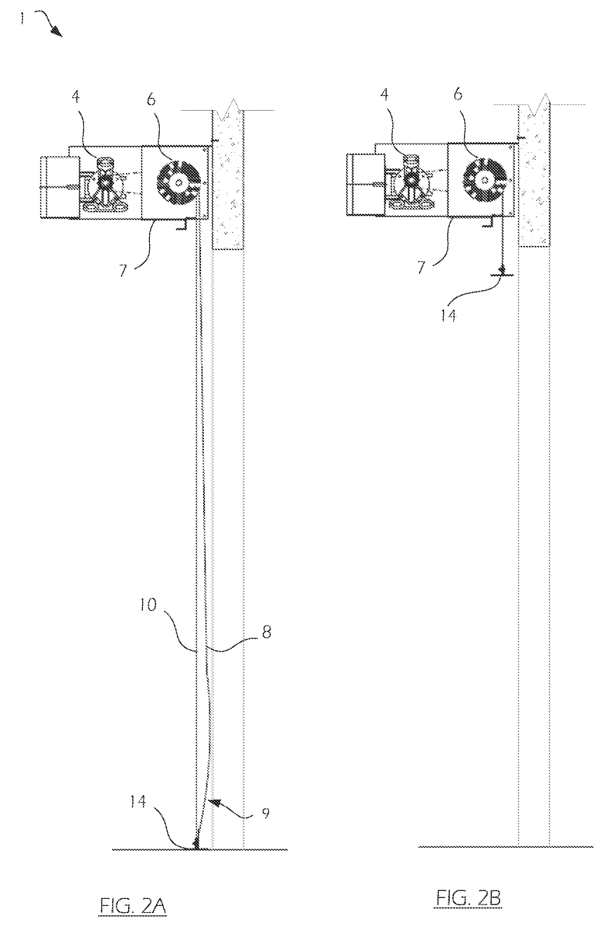

FIG. 1 is a front view of multi-layer rolling fire curtain assembly 1 having a fully deployed multi-layer fire curtain 2. FIG. 2A is a side sectional view of the multi-layer rolling fire curtain assembly 1 shown in FIG. 1 when the fire curtain is deployed. FIG. 2B is a side sectional view of the multi-layer rolling fire curtain assembly 1 shown in FIG. 1 when the fire curtain is retracted. FIGS. 1, 2A and 2B, are best viewed together in the following discussion.

Assembly 1 includes roller 6 is mounted in a roller housing 7. First guide channel 11 and second guide channel 12 extend downward from housing 7 along an opening that will be covered by the multi-layer fire curtain 2 when it is deployed.

Multi-layer fire curtain 2 includes an outer curtain layer 8 and an inner curtain layer 10. Inner curtain layer 10 has a width W₁ such that the lateral edges of inner curtain layer 10 are contained within and guided along first guide channel 11 and second guide channel 12 when multi-layer fire curtain 2 is moved between a retracted and an extended position. The guide channels 11, 12 allow the curtain to be deployed within a “plane of deployment” containing both channels.

Outer curtain layer 8 has a width W_{2 <} W₁ such that the lateral edges of outer curtain layer 8 are not contained within first guide channel 11 and second guide channel 12. In addition, outer curtain layer 8 is longer than inner curtain layer 10, as will be described in more detail below.

The multi-layer fire curtain 2 has a proximal edge connected, directly or indirectly, at one end to the roller 6, drivable by a motor 4, and a leading opposing free edge connected, directly or indirectly, to a bottom bar 14. In embodiments, the layers of multi-layer fire curtain 2 may be connected to roller 6 by clamping, sandwiching, and/or attaching with screws directly to the roller, for example. They may also be sewn or stitched to each other before being connected to the roller by any of those mechanisms. In embodiments, the layers of curtain 2 may also be connected to bottom bar 14 by clamping, sandwiching, and/or attaching with screws. The layers may also be sewn to each other before being connected to bottom bar 14, for example. In further embodiments, two or more layers may be sewn to one layer, which is then attached to either or both of the roller 6 or bottom bar 14.

When the fire curtain 2 is in a fully extended closed position, as in FIGS. 1 and 2A, the bottom bar 14 is parallel with and in contact with the ground. As discussed herein, the term ground refers to any lower surface of the room, building or structure to be protected by multi-layer fire curtain 2 and does not indicate any particular type of material. FIG. 2A also shows baggy area 9, due the difference in length between inner curtain layer 10 and outer curtain layer 8. FIG. 2B shows fire curtain 2 in a mostly retracted position where bottom bar 14 is almost adjacent to roller housing 7. In this position, most of the excess length of outer curtain layer 8 has been absorbed around roller 6 so that baggy area 9 is no longer evident.

In embodiments, multi-layer fire curtain 2 may have three or more layers. In this case, all of the layers would have different lengths with layer one, such as inner curtain layer 10, having the shortest length. The layer two next to layer one would be greater in length than layer one but less than layer three, which may be considered outer curtain layer 8. Multi-layer fire curtains with more than three layers would have similarly staggered lengths from shortest at the inner layer and longest at the outer layer.

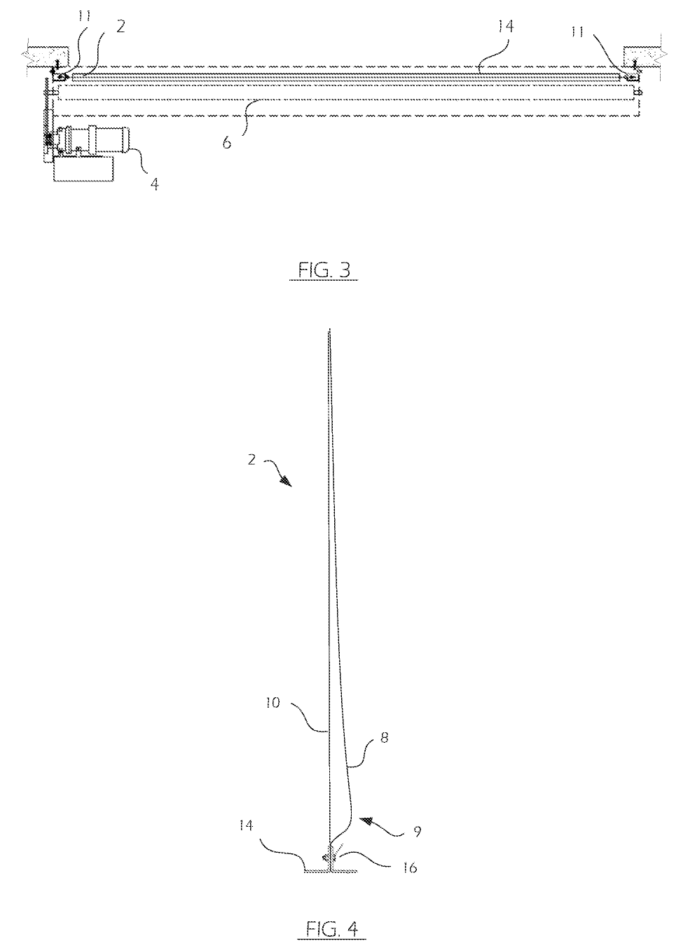

FIG. 3 is a partially see-through plan view of the multi-layer rolling fire curtain assembly 1 shown in FIG. 1. In this view, multi-layer fire curtain 2 is visible, as well as bottom bar 14.

FIG. 4 is a side sectional view of a multi-layer fire curtain 2 according to the present invention showing a lower portion fire curtain 2 when deployed. The outer layer 8 is longer and, for that reason, is loose in comparison with the inner layer 10, which, for any given deployment position, will be relatively tighter that the corresponding portions of the outer layer.

Because the bottom of each layer is attached to the same bottom bar 14 at attachment clamping 16 or all the layers can be attached to each other by, for example sewn together, the longer outer layer 8 will have a tendency to balloon outward forming baggy area 9, due the difference in length with respect to the inner layer 10.

Fire curtain 2 is shown in the figures with two layers, however, more layers may be used. As discussed above, the combination of the different types of flame retardant and smoke blocking layers provides the ability to customize curtains to meet various architectural, structural and safety concerns, such as curtain weight, appearance, strength, durability, smoke rating and fire rating levels, and so on.

It should be understood that if two or more curtain layers are provided with equal width such that the curtain edges of all of the layers reside in the guide channels 11 and 12, venting between the layers will occur. However, the venting will be primarily confined in the guide channels. In contrast, by providing one or more outer curtain layers 8 of a narrower width W₂ as compared to one or more inner curtain layers 10 having a width W_{1 >} W₂ and lateral edges in the guide channels 11, 12, venting between layer(s) 8 and layer(s) 10 can occur outside of the guide channels.

The venting provided by baggy area 9 prevents combustion from occurring in the region between the inner and outer panels (i.e., layers). When lateral edges of both layers are sealed both horizontally and vertically, combustion may occur, due to the presence of oxygen in the air trapped between the layers as well as flammable gases released by layer coatings or internal layer materials when heated by a fire.

By virtue of the horizontal venting, buildup of oxygen, and/or any flammable gaseous mixtures, will be reduced in the gaps between the inner and outer layers.

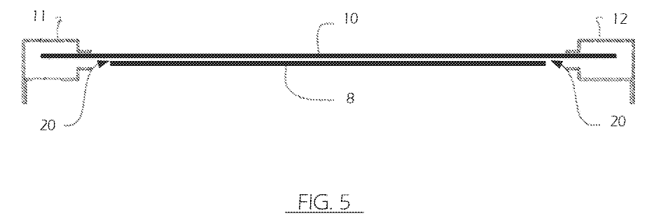

FIG. 5 shows a plan view of multi-layer rolling fire curtain assembly 1. Inner curtain layer 10 extends into first channel guide 11 and second channel guide 12. Because of the difference in width between the layers 8 and 10, a gap 20 is formed between inner curtain layer 10 and outer curtain layer 8, which from the front appears as a baggy area 9 and ends at each side before reaching guide channels 11, 12. The location of gap 20 prevents the guide channels 11, 12 from blocking the flow of air and gases out of the region between inner curtain layer 10 and outer curtain layer 8. Such ventilation properties are important to allow for the dissipation of flammable gases that may build up between the curtains as a result of the curtain fabric, coating used on the curtain fabric and/or pockets of oxygen trapped between the curtain layers.

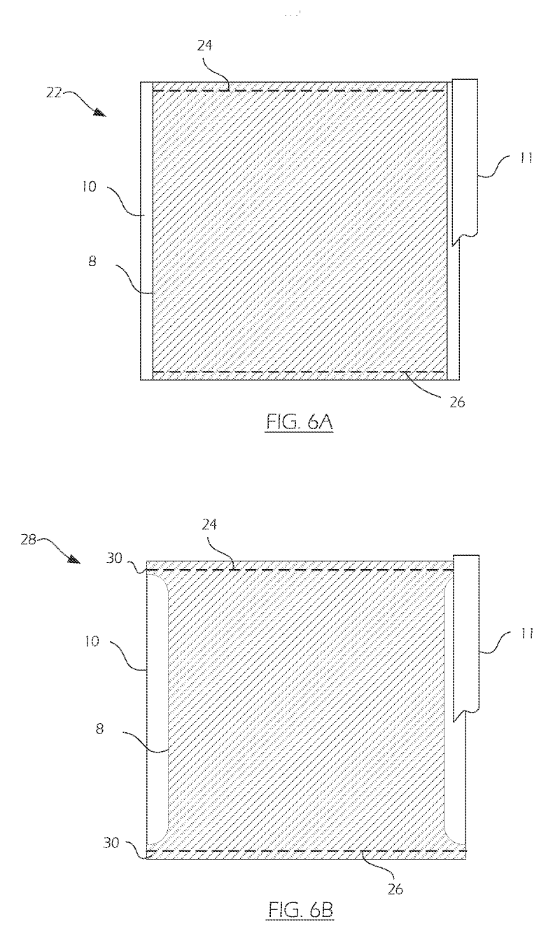

FIG. 6A shows a front view of a multi-layer fire curtain 22. Curtain 22 is an example of multi-layer fire curtain 2 and may be used with any of the embodiments disclosed herein. Curtain 22 includes inner layer 10 and outer layer 8 as shown in FIG. 1. A guide channel 11 is shown partially cut away to illustrate that the edges of inner layer 10 are contained within guide channel 11 but the edges of outer layer 8 are not contained within the guide channel. Inner layer 10 and outer layer 8 are sewn together at top stitching line 24 and bottom stitching line 26. Inner layer 10 and outer layer 8 may be sewn together before multi-layer fire curtain 22 is attached to a roller or bottom bar.

FIG. 6B shows a front view of a multi-layer fire curtain 28. Curtain 28 is an example of multi-layer fire curtain 2 and may be used with any of the embodiments disclosed herein. Curtain 28 includes inner layer 10 and outer layer 8 as shown in FIG. 1. Inner layer 10 and outer layer 8 are sewn together at top stitching line 24 and bottom stitching line 26. Outer layer 8 has a width equal to inner layer 10 at the top and bottom to form tabs 30. A guide channel 11 is shown partially cut away to illustrate that the edges of inner layer 10 are contained within guide channel 11 as are tabs 20 of outer layer 8. The rest of outer layer 8 is not contained within guide channel 11. Inner layer 10 and outer layer 8 may be sewn together before multi-layer fire curtain 22 is attached to a roller or bottom bar.

Although FIGS. 6A and 6B are shown with two layers, multi-layer fire curtains 22 and 28 may also include intermediate layers between inner layer 10 and outer layer 8. One or more of the intermediate layers may have the same width as inner layer 10. One or more of the intermediate layers may have the same width as outer layer 8. Any of the intermediate layers may have the same shape as outer layer 8 shown in FIG. 6B.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

What is claimed is:

1. A multi-layer rolling fire curtain assembly positionable about an opening, comprising:
a rotatable curtain roller positionable about the opening;
first and second guide channels arranged along a right-side edge and a left-side edge of the opening, respectively,
a flexible multi-layer fire curtain comprising fire resistant material and being configured to be wrapped about the curtain roller and to be deployable from the curtain roller between a retracted position and an extended position, the multi-layer fire curtain having a first end connected to the curtain roller, and a second end connected to a bottom bar, the multi-layer fire curtain having:
an inner curtain layer arranged in contact with the curtain roller and having a first width W₁ between first and second lateral edges, and
an outer curtain layer arranged opposite the inner curtain layer, wherein the outer curtain layer has a second width W₂ less than W₁ and is longer than the inner curtain layer to form a baggy area therebetween; and
wherein the multi-layer fire curtain is configured and arranged so as to be received in and guided along a respective one of the first and second guide channels.

2. The multi-layer rolling fire curtain assembly according to claim 1, wherein the multi-layer fire curtain is flexible, establishes a fire barrier across the opening in the extended position, and the inner and outer layers are each made of a fire resistant textile material.

3. The multi-layer rolling fire curtain assembly according to claim 2, wherein the second width W₂ of the outer curtain layer is outside the first and second guide channels to allow for ventilation from between the inner and outer curtain layers.

4. The multi-layer rolling fire curtain assembly according to claim 2, further comprising one or more intermediate layers arranged so as to be sandwiched between the inner and outer fire resistant textile layers.

5. The multi-layer rolling fire curtain assembly according to claim 4, wherein the one or more intermediate layers are made from a fire retardant composite material or a fire retardant metallic material.

6. The multi-layer rolling fire curtain assembly according to claim 4, wherein the one or more intermediate layers have staggered lengths that are longer than the inner curtain layer and shorter than the outer curtain layer.

7. The multi-layer rolling fire curtain assembly according to claim 6, wherein the one or more intermediate layers may have the first width W₁ or the second width W₂.

8. The multi-layer rolling fire curtain assembly according to claim 2, wherein the second width W₂ of the outer curtain layer is outside the first and second guide channels to allow for ventilation from between the inner and outer curtain layers.

9. The multi-layer rolling fire curtain assembly according to claim 1, wherein in a case in which the multi-layer fire curtain is in an extended position, the bottom bar is parallel with and in contact with the ground.

10. The multi-layer rolling fire curtain assembly according to claim 1, wherein the bottom bar is connected to the second end of the multi-layer fire curtain by clamping.

11. The multi-layer rolling fire curtain assembly according to claim 1, wherein the flexible multi-layer fire curtain is connected to the roller directly or indirectly.

12. The multi-layer rolling fire curtain assembly according to claim 1, wherein the flexible multi-layer fire curtain is connected to the bottom bar directly or indirectly.

13. The multi-layer rolling fire curtain assembly according to claim 1, wherein the inner and outer curtain layers are sewn together before being connected to the curtain roller.

14. The multi-layer rolling fire curtain assembly according to claim 1, wherein the lateral edges of the outer curtain layer at the second width W₂ do not extend into the guide channels, so as to form an opening at each lateral edge of the outer curtain layer.

15. The multi-layer rolling fire curtain assembly according to claim 1, further comprising a motor configured to drive the rotatable curtain roller to wind the multi-layer fire curtain onto the rotatable curtain roller.

16. The multi-layer rolling fire curtain assembly according to claim 1, wherein the curtain roller is connected to the first end of the multi-layer fire curtain by clamping.

17. The multi-layer rolling fire curtain assembly according to claim 1, wherein the inner and outer curtain layers are sewn together before being connected to the bottom bar.
